(19) United States
(12) Patent Application Publication
(10) Pub. No.: US 2024/0232732 A9
(43) Pub. Date: Jul. 11, 2024

(54) VR Simultaneous (Twin) Screening linked to Real World Screening Ticketing and Viewing Process

(71) Applicant: PreTechnology, Inc., New York, NY (US)

(72) Inventor: Stacy Spikes, New York, NY (US)

(21) Appl. No.: 18/373,255

(22) Filed: Sep. 26, 2023

Related U.S. Application Data
(60) Provisional application No. 63/377,097, filed on Sep. 26, 2022.

(51) Int. Cl. G06Q 10/02; H04N 21/2187; H04N 21/2543; H04N 21/414

(52) U.S. Cl. CPC G06Q 10/02; H04N 21/2187; H04N 21/25435; H04N 21/41407; H04N 21/41415

(57) ABSTRACT

Disclosed herein are a method and apparatus for providing movie theaters the opportunity to expand their screening footprint during the theatrical release window of a movie to the metaverse. The process involves three areas. Ticketing, VR Viewing and piracy protection. A movie that is playing at a select theater will have a twin screening in the metaverse using a virtual reality (VR) theater that will play simultaneously.

### RELATED APPLICATIONS

The present patent application claims priority from U.S. Provisional Patent Application No. 63/377,097, filed Sep. 26, 2022, which is incorporated by reference in its entirety herein.

### BACKGROUND

Currently movie theaters play advertisements and previews of other movies when patrons attend. The traditional model is for theater patrons to actually go to a theater and pay for a ticket in order to watch a particular movie. There is no facility at present that allows movie theaters to expand their screening footprint during the theatrical release window of a movie beyond the known in-theater experience.

### BRIEF DESCRIPTION OF THE DRAWINGS

Features and objects of the present invention and the manner of attaining them will become more apparent, and the invention itself will be best understood, by reference to the following description of one or more embodiments taken in conjunction with the accompanying Figures.

The Figures depict embodiments of the present invention for purposes of illustration only. One skilled in the art will readily recognize from the following discussion that alternative embodiments of the structures and methods illustrated herein may be employed without departing from the principles of the invention described herein.

Embodiments of the present invention are hereafter described in detail with reference to the accompanying Figures. Although the invention is described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

FIG. 1 is a flow diagram illustrating how the system and method operate according to an embodiment.

FIG. 2 is a diagram illustrating ticket purchase options according to an embodiment.

FIG. 3 is a diagram illustrating ticket purchase options according to an embodiment.

### DETAILED DESCRIPTION

Disclosed herein are a method and apparatus for providing movie theaters the opportunity to expand their screening footprint during the theatrical release window of a movie to the metaverse. The process involves three areas. Ticketing, VR Viewing and piracy protection. A movie that is playing at a select theater will have a twin screening in the metaverse using a virtual reality (VR) theater that will play simultaneously. As in the “real” world, the screening in the VR screening cannot be stopped, paused, or rewound by the viewer. There may be the ability delay for a few moments but not in the sense of traditional playback found in video.

In all of the following description, a movie is used as an example of an event or showing that a person/consumer/customer can purchase a ticket for. However, the person/consumer/customer can also purchase tickets for any other events, such as live events at concert venues or plays at live venues.

The user interacts with the ticketing process by accessing an application as disclosed herein, or a website. The user can then select the film that they would like to see followed by a theater and a showtime. At that point the user has the ability to select a ticket to the movie for in person or in VR viewing. Once the VR ticket is selected the purchase in payment for the transaction is completed. This would also cover free tickets or comp or subscription tickets. Some theaters in VR may have actual seat locations in the VR theater or not. The payment of the VR ticket is processed in the same way that a “normal” ticket is processed, and the accounting is the same for accounting purposes on behalf of the theater and the studio. Once the ticket is paid for the customer receives a confirmation code that is placed into the VR theater system directly by the consumer or automatically by the system that will grant the customer access to see the movie at the determined start time. The movie starts simultaneously in VR as it does in the theater in the real world.

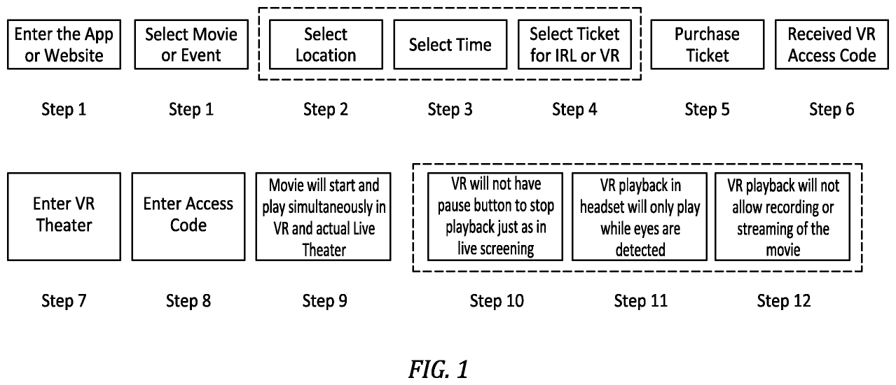

FIG. 1 is a flow diagram illustrating how the system and method operate from a consumer's view according to an embodiment.

At step 1, the consumer enters the web site or an online application to access movies and selects a movie or event.

The web site is supported by a twin screening system that includes multiple processors and memory devices as is known in the prior art. The consumer interacts with the system via a user interface that can be presented in a mobile device or a desktop computer, or any other well-known means of accessing web sites.

At step 2, the consumer selects a location. At step 3, the consumer selects a time. At step 4, the consumer selects a ticket for in real life (IRL) or virtual reality (VR). At step 5, the consumer purchases the ticket. At step 6, the consumer receives a VR access code.

At step 7, Once the consumer has the VR access code, he/she can enter the VR theater. At step 8, the consumer enters an access code received in the process, for example at step 6.

At step 8, the consumer enters the access code. At this point the movie will start and play simultaneously in VR and actual live theater. Regarding steps 10, 11, and 12, in step 10 VR will not have a pause button to stop playback just as in live streaming. At step 11, the VR playback in a headset will only play while eyes are detected. If eyes are not detected, VR playback is not enabled. The person in the metaverse has the ability to see and be at the event in reality and the person in the real world will be able to see an avatar of the person in the metaverse, thus sharing the experience.

At step 12, VR playback will not allow recording or streaming of the movie that has been selected.

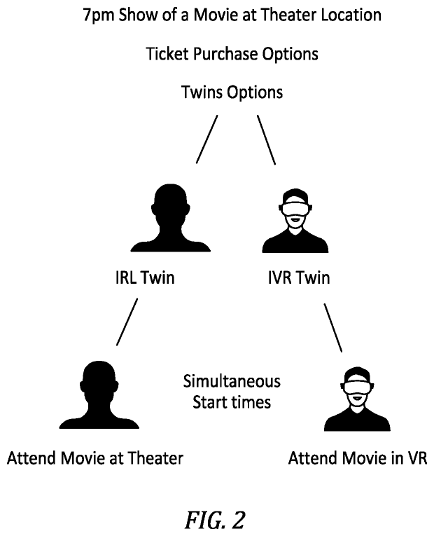

FIG. 2 is a diagram illustrating ticket purchase options according to an embodiment. As shown, a patron has ticket purchase options. One is a “twins” option whereby the patron purchases an IRL ticket and a VR ticket. The start times for the movie are simultaneous for the IRL ticket and the VR ticket. The patron can attend a movie theater to experience the IRL version, or attend the movie in VR, or both.

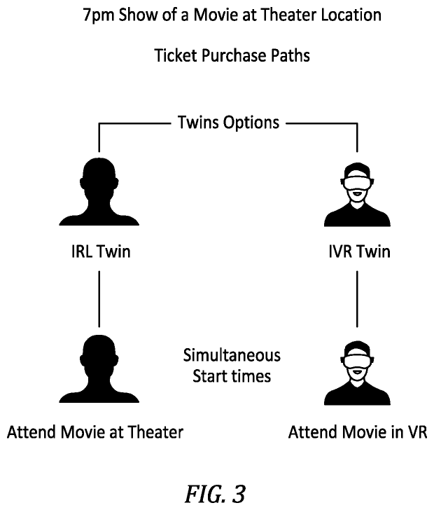

FIG. 3 is a diagram illustrating ticket purchase options according to an embodiment. As illustrated, in this case, separate tickets are purchased for each of the IRL and VR options. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

Included in the description are flowcharts depicting examples of the methodology which may be used to conduct a goal-directed semantic search. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words”, or the like. These specific words, however, are merely convenient labels and are to be associated with appropriate information elements.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which will be set forth in the forthcoming claims.

What is claimed is:

1. A method for providing a twin screening experience for events, the method comprising:
a twin screening system receiving a communication from a consumer who wishes to purchase a ticket for an event;
the twin screening system receiving a communication from the consumer indicating which event the consumer wishes to view; and
the twin screening system receiving a communication from the consumer indicating whether the consumer would like to purchase a ticket to attend the live event, attend the event in virtual reality (VR), or both.

2. The method of claim 1, further comprising the twin screening system providing the consumer with a VR access code.

3. The method of claim 1, further comprising the twin screening system providing a simultaneous start time for the VR event and the live event.

4. The method of claim 1, further comprising the twin screening system providing a simultaneous start time for the VR event and the live event.

5. The method of claim 1, further comprising the twin screening system providing a facility for one person to attend the live event and for another person to simultaneously attend the VR event and share the experience.
